(19) United States
(12) Patent Application Publication
(10) Pub. No.: US 2013/0004752 A1
(43) Pub. Date: Jan. 3, 2013

(54) METHOD FOR APPLYING CARBON/TIN MIXTURES TO METAL OR ALLOY LAYERS

(76) Inventors: Udo Adler, Koblenz (DE); Dirk Rode, Osnabruck (DE); Isabell Buresch, Illertissen (DE); Jian Wang, Fremont, CA (US); Dominique Freckmann, San Francisco, CA (US); Helge Schmidt, Speyer (DE)

(21) Appl. No.: 13/511,646

(22) PCT Filed: Oct. 1, 2010
(86) PCT No.: PCT/DE2010/001165

§ 371 Date: Aug. 10, 2012

(30) Foreign Application Priority Data
Nov. 25, 2009 (DE) 10 2009 054 427.5

(51) Int. Cl. H01B 1/02; B05D 5/12; B32B 15/02; B32B 9/00; B32B 3/10; B82Y 40/00; B82Y 30/00

(52) U.S. Cl. 428/208; 428/323; 427/122; 428/457; 252/503; 977/742; 977/734; 977/842; 977/773; 977/932

(57) ABSTRACT

The invention relates to a method for applying to a substrate a coating composition containing carbon in the form of carbon nanotubes, graphenes, fullerenes, or mixtures thereof and metal particles. The invention further relates to the coated substrate produced by the method according to the invention and to the use of the coated substrate as an electromechanical component.

The invention relates to a method for applying a coating composition containing carbon in the form of carbon nanotubes, graphenes, fullerenes or admixtures thereof and metal particles, to a substrate. The invention further relates to the coated substrate which is produced by the method according to the invention and the use of the coated substrate as an electromechanical component or as strip conductors in electrical and electronics applications.

Carbon nanotubes (CNTs) were discovered by Sumio Iijama in 1991 (see S. Iijama, Nature, 1991, 354, 56). Iijama found in the soot of a fullerene generator, under specific reaction conditions, tube-like structures of only a few 10 nm in diameter, but up to several micrometres in length. The compounds found by him comprised a plurality of concentric graphite tubes which became referred to as multi-wall carbon nanotubes (MWCNTs). Shortly afterwards, single-wall CNTs having a diameter of only approximately 1 nm were found by Iijama and Ichihashi and were accordingly referred to as single-wall carbon nanotubes (SWCNTs) (cf. S. Iijama, T. Ichihashi, Nature, 1993, 363, 6430).

The outstanding properties of the CNTs include, for example, their mechanical tensile strength and rigidity of approximately 40 GPa or 1 TPa (20 or 5 times higher than that of steel, respectively).

In the CNTs, there exist both conductive and semiconductive materials. The carbon nanotubes belong to the family of fullerenes and have a diameter of from 1 nm to a few hundreds of nm. Carbon nanotubes are microscopically small, tube-like structures (molecular nanotubes) comprising carbon. Their walls comprise, similarly to those of fullerenes or the planes of graphite, only carbon, with the carbon atoms taking up a honeycomb-like structure having six corners and three bonding partners (determined by the sp² hybridisation). The diameter of the tubes is generally in the range from 1 to 50 nm, but with tubes having diameters of only 0.4 nm also being produced. Lengths of several millimetres for individual tubes and up to 20 cm for tube assemblies have already been achieved.

It is known in the prior art for nanotubes to be mixed with conventional plastics material. The mechanical properties of the plastics materials are thereby substantially improved. It is further possible to produce electrically conductive plastics materials, for example, nanotubes have already been used to make antistatic films conductive.

As already set out above, carbon nanotubes belong to the group of fullerenes. Spherical molecules comprising carbon atoms which have a high degree of symmetry and which constitute the third element modification of carbon (besides diamond and graphite) are referred to as fullerenes.

Monoatomic layers of sp²-hybridised carbon atoms are referred to as graphenes. Graphenes have very good electrical and thermal conductivity along their plane.

Tin or tin alloys are usually used to solder electrical contacts, for example, in order to connect copper wires to each other. Tin or tin alloys are also often applied to plug type connections in order to improve the friction coefficient, to protect from corrosion and also to contribute to the improvement in the conductivity. Problems in tin and tin alloys include the tendency towards frictional corrosion, the friction coefficient and in particular the softness of the metal or the alloy so that the tin-containing coating becomes worn away in particular if plug type connectors are often disengaged and connected and in the event of vibrations, and consequently the advantages of the tin-containing coating become lost. Similar problems also occur when using other metals or alloys, for example, with Ag, Au, Ni or Zn.

A coating which does not have the problems involving wear or which has them only to a lesser extent, and which does not have any disadvantages with regard to the electrical conductivity and the insertion and withdrawal forces would be advantageous in this context. This could be achieved, for example, by adding carbon to the coating metal. The addition of carbon could substantially increase the hardness of the coating on a substrate. However, this is at the expense of the conductivity when using conventional carbon particles. Furthermore, it is difficult to achieve a homogeneous admixture of carbon with the “coating metal”.

Consequently, an object of the present invention is to provide a method for coating a substrate with a coating composition which contains carbon and metal.

The object is achieved by a method for applying a coating composition to a substrate comprising the steps of:
a) producing a coating composition by physical and/or chemical mixing of carbon in the form of carbon nanotubes, graphenes, fullerenes or admixtures thereof with metal particles,
b) planar or selective application of the coating composition to a substrate or
c) planar or selective introduction of the coating composition into a previously applied coating/into a previously applied substrate.

The previously applied coating or the previously applied substrate may be intermediate layers, for example, layers containing Cu, Ni, Ag, Co, Fe and/or alloys thereof

Metal particles containing Cu, Sn, Ag, Au, Pd, Ni and/or Zn and alloys thereof are preferably used as the metal particles for the coating composition. In one embodiment of the invention, it has been found to be advantageous for the metal particles to have a mean particle size (d₅₀) in the range from 10 to 200 μm, preferably from 25 to 150 μm, more preferably from 40 to 100 μm. The mean particle size may be established, for example, via XRD.

In another embodiment of the invention, it is preferable for the metal particles to have a mean particle size in the range from 8 nm to 500 nm, preferably from 10 nm to 250 nm. Those particle sizes are particularly advantageous when the application of the coating composition is carried out via an ink jet method.

In another embodiment of the invention, it is preferable for the metal particles to have a mean particle size in the range from 50 to 1000 nm, preferably from 100 nm to 500 nm. Those particle sizes are particularly advantageous if the application of the coating composition is carried out via an aerosol jet method.

Multi-wall carbon nanotubes (MWCNTs) or single-wall carbon nanotubes (SWCNTs) are preferably used as the carbon nanotubes. The carbon nanotubes preferably have a diameter of from 1 nm to 1000 nm.

In the context of this invention, the mixing of the carbon with the metal particles is preferably carried out in the dry or wet state. The application of the coating composition is accordingly also carried out in the dry form or wet form.

The mixing of the components of the coating composition (wet or dry) is preferably carried out by means of mixing devices, for example, with a ball mill, a speed mixer, mechanical agitators, kneading machines, extruders, etc.

In a preferred embodiment, the mixing of the carbon with the metal particles is carried out in the wet state, so much solvent (fluid dispersion medium) being added that a paste or dispersion (in particular a suspension) is produced.

During mixing in the wet state, one or more additives/surface-active agents may be added. The additives/surface-active agents are preferably selected from surfactants, antioxidation media, flow media and/or acidic media.

The surfactants which may be of a non-ionic, anionic, cationic and/or amphoteric type particularly contribute to obtaining a stable dispersion or suspension. Suitable surfactants in the context of the invention are, for example, octylphenol ethoxylate (Triton), sodium lauryl sulphate, CTAB (cetyltrimethylammonium bromide), poly(sodium-4-styrene sulphonate) or gum Arabic.

The antioxidation media, flow media and/or acidic media are intended to bring about improved adhesion of the coating composition to the substrate and therefore activation of the substrate surface. Furthermore, metal oxides are again intended to be reduced to the metal and consequently conductive form. Suitable antioxidation media are, for example, selected from anorganic salts such as tin chloride dissolved in hydrochloric acid, sodium sulphite or calcium sulphite and the like.

Flow media are additives which are intended to facilitate the melting operation and the handling of molten substances. Flow media are added during metal processing and in salt melts in order to reduce the melting temperature and the viscosity (viscousness). In addition, a function as oxidation protection is also conferred on them in some methods. Suitable flow media in the context of this invention are, for example, boron compounds such as boron hydride acids, fluorine compounds such as hydrofluoric acids, phosphates, silicates or metal chlorides, in particular zinc chloride, and ammonium chloride and colophonium.

Suitable acidic media in the context of this invention are in particular diluted anorganic acids such as, for example, hydrochloric acid having a concentration of <5 mol %, preferably from 1 to 4.5 mol %, particularly preferably from 2 to 4 mol %.

The coating composition may be applied to the substrate in the wet state as a paste or as a dispersion. This may, for example, be carried out by injection, spraying, doctor-blading, immersion, rolling and the like, or a combination of the methods mentioned. These techniques are known to the person skilled in the art. The coating composition can further be completely or partially applied to the substrate. For selective application, the methods conventional in printing technology such as, for example, rotogravure, screen printing or stamp printing, may be used. Furthermore, control can be carried out accordingly, for example, via ink jet techniques in order to partially apply the spray stream during spraying operation.

In order to further increase the adhesion of the coating composition, the substrate can be heated before or during the application of the coating composition, preferably to a temperature of from 50 to 320° C., particularly preferably from 80 to 300° C.

After the coating composition has been applied in the wet state (as a paste or dispersion), a thermal processing operation is preferably carried out at a temperature of from>150° C. to 1000° C., preferably from 200 to 950° C., particularly preferably from 250 to 900° C.

In another embodiment of the invention, the coating composition is applied to the substrate in the dry state, that is to say, without any solvent, as a powdered admixture. The dry coating composition is preferably heated up to the molten state and applied to the substrate. The coating composition can again be applied by means of injection, spraying, doctor-blading, immersion, rolling and the like. Those techniques are known to the person skilled in the art. The coating composition can further be applied completely or partially to the substrate. During partial application, for example, masks may be used or it is possible to control the spray stream accordingly during spraying.

The substrate is advantageously processed with an antioxidation medium, flow medium and/or acid medium and/or heated before the coating composition is applied. The substrate is precoated with metal particles in another preferred embodiment. The metal particles preferably contain the metal or preferably comprise the metal which is used in the corresponding coating composition. The substrate may also be provided with additional intermediate layers such as Cu, Ni, Ag, Co, Fe and alloys thereof.

After the coating composition has been applied in the dry state (as a melt), thermal processing is preferably carried out at a temperature of>150° C. to 1000° C., preferably from 200 to 950° C., particularly preferably from 250 to 900° C. In the context of the invention, it is further preferable for the coating to be homogenised after the application by pressure and/or temperature. For example, a stamp or a roller may apply pressure to the coating and may simultaneously be heated in order to achieve melting of the coating. This results in improved homogenisation of the coating on the substrate.

A metal-containing substrate is preferably used as the substrate which is coated with the coating composition. However, it is also possible to use a non-metallic plastics material as the substrate. The metal-containing substrate is preferably selected from copper, copper alloys, nickel and nickel alloys, aluminium and aluminium alloys, steels, tin alloys, silver alloys, metallised plastics materials or metallised ceramic materials.

The invention further relates to a coated substrate which can be obtained by the method according to the invention. The coated substrate is distinguished in that it has a homogeneous coating containing carbon in the form of carbon nanotubes, graphenes, fullerenes or admixtures thereof with metal particles. The substrate may further have intermediate layers.

Metal particles containing Cu, Sn, Ag, Au, Pd, Ni and/or Zn are preferably used as the metal particles for the coating composition. The metal particles may also be present in the form of an admixture or alloy of the elements. It has been found to be advantageous for the metal particles to have a mean particle size (d₅₀) in the range from 10 to 200 μm, preferably from 25 to 150 μm, more preferably from 40 to 100 μm. It is advantageous, for applying the coating composition via the ink jet or aerosol jet method, for the particle size to be in the range from 8 nm to 300 nm or from 50 nm to 1000 nm, preferably from 10 nm to 250 nm or from 100 nm to 500 nm. The mean particle size may be established, for example, via XRD.

The carbon nanotubes are preferably multi-wall carbon nanotubes (MWCNTs) or single-wall carbon nanotubes (SWCNTs). The carbon nanotubes preferably have a diameter of from 1 nm to 1000 nm and a length of<50 μm, preferably of 1 μm and particularly 200 nm.

The synthesis of the carbon nanotubes is preferably carried out by depositing carbon from the gas phase or a plasma. These techniques are known to the person skilled in the art.

The fullerenes used according to the invention are spherical molecules comprising carbon atoms having a high degree of symmetry. The production of the fullerenes is preferably carried out by vaporising graphite under reduced pressure and under a protective gas atmosphere (for example, argon) with resistance heating or arcing. The carbon nanotubes already mentioned above are often produced as a by-product. The fullerenes have semiconductive to superconductive properties.

The graphenes used according to the invention are monoatomic layers of sp²-hybridised carbon atoms. The graphenes have very good electrical and thermal conductivity along their plane. The production of the graphenes is preferably carried out by splitting graphite into its basal planes. Oxygen is first intercalated. The oxygen partially reacts with the carbon and results in a mutual separation of the layers. Subsequently, the graphenes are suspended and processed in the coating composition.

Another possibility for constituting individual graphene layers is the heating of hexagonal silicon carbide surfaces to temperatures above 1400° C. Owing to the higher vapour pressure of the silicon, the silicon atoms evaporate more quickly than the carbon atoms. Thin layers of single-crystal graphite which comprise a small number of graphene monolayers are then formed at the surface.

The coated substrate may be used as an electromechanical component, the substrate having a low level of mechanical wear and low insertion and withdrawal forces owing to a reduced friction coefficient and further having very good electrical conductivity.

The invention may be used, for example, for the following applications:
partial coatings on strip materials for electromechanical components and plug type connector applications,
strip conductors on printed circuit boards with contacting connection,
strip conductors as lead frames with contacting connection,
strip conductors in FFCs and FPCs,
Moulded Interconnected Devices (MIDs).

The invention will now be explained in greater detail with reference to a number of embodiments, but they are not intended to be considered to limit the scope of the invention. Reference is further made to the Figures, in which:

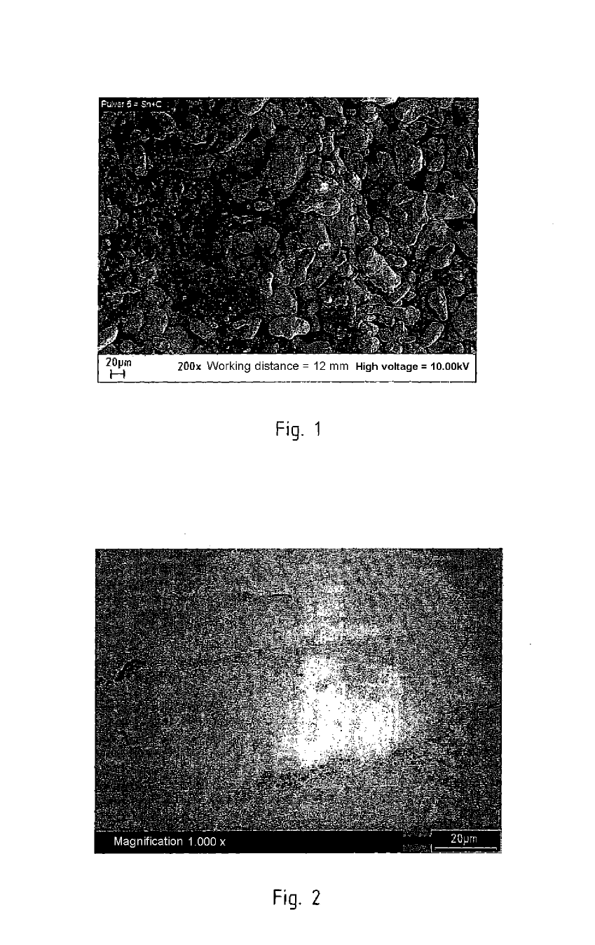

FIG. 1 is a microscopic exposure of an Sn powder (of Ecka granules) with a particle size <45 μm with 2.1% by weight of CNTs, mixed in a ball mill under protective gas; the length of the measuring bar is 20 μm; the exposure was taken at a voltage of 10 kV;

FIG. 2 is a microscopic exposure of an admixture of Sn and CNT powder which has been melted in a pot under pressure. It is possible to see non-homogeneous CNT distribution in the cast block/ground section; the length of the measuring bar is 20 μm and the exposure was taken at a voltage of 1 kV;

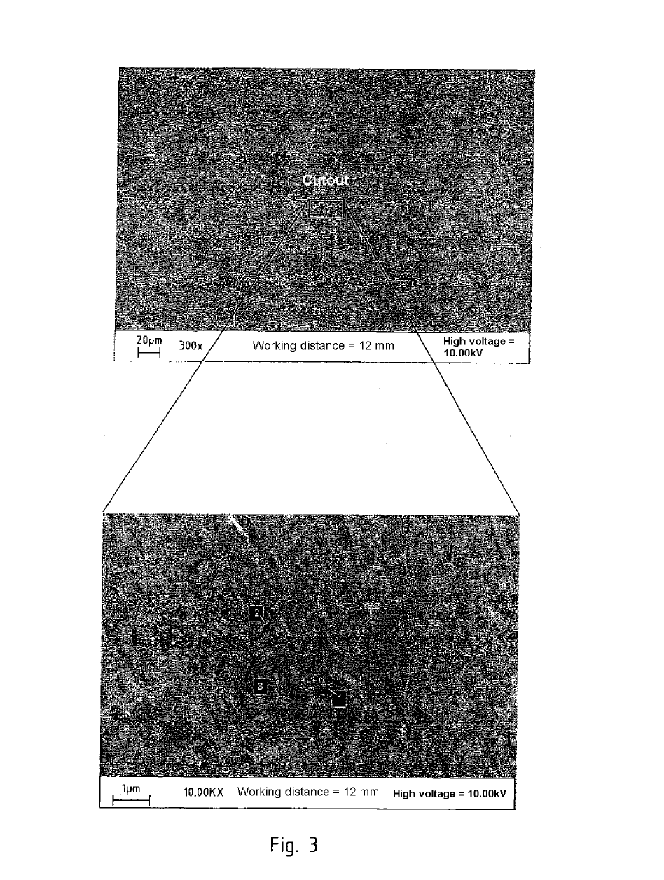

FIG. 3 shows an admixture of Sn and CNT powder which has been scattered on a Cu strip sample which was hot-dip tinned. The powder was subsequently melted at 260° C. and simultaneously pressed; the length of the measuring bar of the enlarged exposure is 1 μm; this exposure was taken at a voltage of 10 kV and

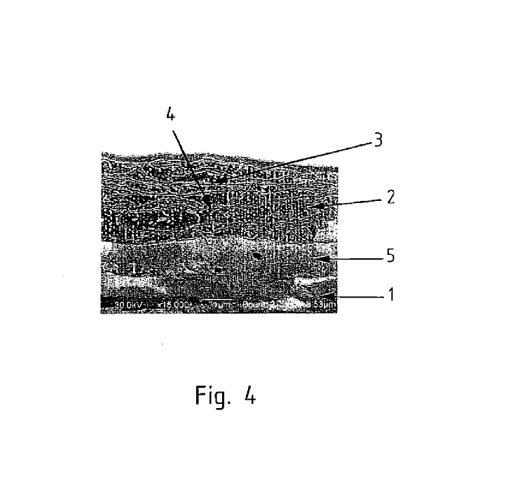

FIG. 4 is an FIB exposure (Focused Ion Beam) of a cross-section through a substrate 1 after application of a coating 2 according to the invention; the size of the range depicted in the FIB exposure is 8.53 μm; the exposure was produced at a voltage of 30 kV.

### EMBODIMENTS

### Example 1

Sn powder (particle size <45 μm, see FIG. 1) was mixed with 2.1% by weight of CNTs in a ball mill under an Ar atmosphere and that powder was scattered on a Cu strip sample which was hot-dip tinned. The powder was subsequently melted at 260° C. and simultaneously rolled (pressed) (see FIG. 3).

Beforehand, the Sn+CNT powder admixture was melted under pressure in a pot in order to investigate the distribution of the CNTs in the Sn matrix (see FIG. 2). A substantially more homogeneous distribution of the CNTs is clearly visible.

The powder was further melted on the Sn surface and pressed and subsequently removed in order to obtain the CNTs in the Sn matrix owing to the growth of the intermetallic phase at the surface, where the effect becomes evident in relation to the insertion and withdrawal forces.

### Example 2

The coating in FIG. 4 comprises graphenes 3 which are mixed with Sn powder. A CuSn₆ plate is used as the substrate.

Substrate 1 and coating 2 are melted under pressure and temperature and the melt is allowed to set again. As can be seen in the FIB exposure, the graphenes 3 have become positioned around the Sn particles 4 in the solidified melt of the coating 2 and enclose them. In addition to the substrate 1 and the coating 2, a two-layered intermetallic Cu/Sn intermediate layer 5 can also be seen and is produced owing to the melting between the substrate 1 and coating 2.

### REFERENCE NUMERALS

1—Substrate
2—Coating
3—Graphenes
4—Sn particles
5—Intermediate layer

1. Method for applying a coating composition to a substrate comprising the steps of:
a) producing a coating composition by physical and/or chemical mixing of carbon in the form of carbon nanotubes, graphenes, fullerenes or admixtures thereof with metal particles,
b) planar or selective application of the coating composition to a substrate or
c) planar or selective introduction of the coating composition into a previously applied coating/into a previously applied substrate.

2. Method according to claim 1, wherein metal particles containing Cu, Sn, Ag, Au, Pd, Ni, Zn and/or alloys thereof are used as the metal particles.

3. Method according to claim 1, wherein the metal particles have a mean particle size in the range from 10 to 200 μm.

4. Method according to claim 1, wherein the metal particles have a mean particle size in the range from 8 nm to 500 nm.

5. Method according to claim 1, wherein the metal particles have a mean particle size in the range from 50 to 1000 nm.

6. Method according to claim 1, wherein the mixing of the carbon with the metal particles is carried out in the dry or wet state.

7. Method according to claim 6, wherein during the mixing in the wet state, so much solvent is added that a paste or dispersion is produced.

8. Method according to claim 7, wherein during mixing in the wet state, one or more additives is/are added.

9. Method according to claim 8, wherein the additives are selected from surfactants, antioxidation media, flow media and/or acid/activating media.

10. Method according to claim 6, wherein the coating composition is applied to the substrate in the dry form as a powder or in the wet form as a paste or as a dispersion/suspension.

11. Method according to claim 10, wherein the coating composition is subjected to a thermal processing operation after application to the substrate.

12. Method according to claim 6, wherein the dry coating composition is heated up to the molten state and applied to the substrate.

13. Method according to claim 6, wherein the substrate is processed with an antioxidation medium, flow medium and/or acid medium and/or heated before the coating composition is applied.

14. Method according to claim 1, wherein the application of the coating composition is carried out partially.

15. Method according to claim 14, characterised in that the substrate is precoated with metal particles.

16. Method according to claim 1, wherein a non-metallic plastics material is used as the substrate.

17. Method according to claim 1, wherein a metal-containing substrate is used as the substrate.

18. Method according to claim 17, wherein copper, copper alloys, steel, nickel, nickel alloys, tin, tin alloys, silver, silver alloys, metallised plastics materials or metallised ceramic materials are used as the metal-containing substrate.

19. Method according to claim 1, wherein the coating is homogenised by pressure and/or temperature after application.

20. Coated substrate which can be obtained according to the method of claim 1.

21. Use of the coated substrate according to claim 20 as an electromechanical component.

22. Use of the coated substrate according to claim 20 in order to conduct electric current in electrical and electronic applications.
